(19) United States
(12) Patent Application Publication
(10) Pub. No.: US 2010/0227190 A1
(43) Pub. Date: Sep. 9, 2010

(54) METHOD FOR THE UNIFORM APPLICATION OF A COATING TO A TUBULAR WALL

(75) Inventor: Wilfried Lochte, Boxtel (NL)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/160,318

(22) PCT Filed: Jan. 9, 2007
(86) PCT No.: PCT/EP2007/000110

§ 371 Date: Apr. 3, 2009

(30) Foreign Application Priority Data
Jan. 17, 2006 (DE) 10 2006 002 369.2

(51) Int. Cl. B32B 1/08; B05D 1/00; B05D 1/26; B05D 3/02; B05D 3/00; B05D 3/12; B05D 3/14; B05C 3/00; B32B 15/095

(52) U.S. Cl. 428/586; 427/430.1; 427/331; 427/385.5; 427/398.1; 427/171; 427/540; 118/429; 428/35.9

(57) ABSTRACT

The invention relates to a method for the uniform application of a coating of reactive coating materials, preferably polyurethane components, to tubular walls (20), and also relates to a coating device and a composite tube produced by means thereof. In order to apply a uniform coating thickness, it is proposed according to the invention that the tubular wall (20) is supplied continuously into a coating device (1) in which coating materials are supplied to at least one distributing duct which opens towards the tubular wall (20) and merges in the direction of transport into a coating duct (14), wherein the coating materials flow into the distributing duct (12) without a dead volume and pass from there to the surface of the tubular wall (20) and are held in a tightly restricted space until solidification. This measure ensures that, taking into consideration the transport speed of the tubular wall (20) and the length of the coating duct, hardening of the coating materials has initiated before the tubular wall (20) exits the coating device (1), and therefore a very precisely maintained layer thickness is generated

The invention relates to a method for uniform application of a coating of coating materials capable of reaction, preferably polyurethane components, onto tubular walls, as well as to a coating device and a composite pipe produced using the coating device.

The composite pipes produced using the method can consist of an inner metal pipe, for example steel pipe, or of a fiberglass-reinforced plastic pipe, a PE pipe, or a polyolefin pipe, onto which polyurethane is applied for gluing to other external layers. In this connection, the polyurethane is supposed to be permanently elastic and compressible, and is used to thermally insulate the tubular wall. In a particular embodiment, for example in the case of PE pipes, the outer layer can additionally have a particularly thin aluminum foil wrapped around it. In this connection, the aluminum foil represents a barrier for the substances that diffuse through the PE. Pipes structured in this manner are used, for example, for utility lines, particularly for district heating pipes. In this connection, PE pipes are produced in one process, for example by means of extrusion, and coiled up onto drums, in great lengths. For further processing, particularly for having the aluminum foil wrapped around them, the prior application of coating materials, particularly of coating materials capable of reaction, is necessary, so that the aluminum can be glued onto them. Only afterwards are additional insulation layers applied. So that tearing of the aluminum layer is prevented after it is applied, it is necessary that the coatings capable of reaction are applied in a thickness that is strictly observed and pre-determined.

According to a known production method, subsequent application of the coating to the tubular wall takes place by means of spraying or brushing it on. However, in this way, it is not possible to guarantee a uniform layer thickness, and this is particularly necessary in the case of PE pipes with aluminum foil. In the case of a low layer thickness, air bubbles or interruptions can furthermore occur, and these are undesirable.

A heat-insulated conduction pipe and a method for its production are known from DE 33 07 865 A1. This is a pipe welded with a longitudinal seam, which has an inner pipe and an outer pipe, and a heat insulation layer of foamed plastic disposed between the inner pipe and the outer pipe. However, the method used in this connection is relatively complicated and cost-intensive.

An extruded plastic/metal composite pipe for installation purposes is known from EP 0 567 667 A1, which has a plastic outer layer and a reinforcement layer disposed between the plastic inner pipe and the outer layer.

Furthermore, a method and a device for the production of a multi-layer plastic composite pipe is known from DE 195 07 224 A1, in which the edges of the metal foil overlap, and the foil layers that lie metallically on top of one another in the overlap region are welded using electrode irradiation.

The present invention is based on the task of indicating a method as well as a coating device with which uniform coating of tubular walls is possible, as well as a composite pipe that has the required conditions of a uniform outer coating for further processing.

According to the invention, it is provided, in order to accomplish the method task, that continuous feed of the tubular wall into a coating device takes place, in which coating materials are passed to at least one distribution channel free of dead volume, which opens toward the tubular wall and makes a transition, in the transport direction, into a coating channel, whereby the coating materials flow into the distribution channel and get from there to the surface of the tubular wall, and are held in a closely limited space until they solidify. Other advantageous embodiments are evident from the dependent method claims.

The tubular wall that is to be provided with the coating is continuously fed to the coating device; at the same time, the coating materials are fed in by way of at least one distribution channel that is free of dead volume, which channel opens toward the tubular wall and makes a transition into a coating channel in the transport direction. In this connection, it is important that the coating materials flow into the distribution channel free of dead volume. Free of dead volume is understood to mean a volume in which no eddies and also no stoppages of volume elements occur, so that it is ensured that no residual materials remain adhering to the walls and possibly harden there. For this reason, the flow profile should be as progressive as possible, in other words the flow velocity during transport of the reactants should be at least uniformly increasing, or better, continuously increasing. For this purpose, the distribution channel is structured in the form of a ring groove, in such a manner that taking the expansion of the reactants during the reaction into consideration, the ring groove first widens into a passage opening for the tubular wall to be coated, and subsequently makes a transition into a defined, slit-shaped coating channel, which is configured to be slightly larger than the tubular wall. Alternatively, it can be provided that the coating channel conically narrows slightly in the transport direction of the tubular wall, whereby at the same time, partial curing of the polyurethane mixture within the conically narrowing coating channel takes place. Preferably, a coating is applied to the outside of the tubular wall. In order to prevent adhesion of the coating materials in the gauge as much as possible, it is provided, in a further development of the invention, that after feed of the coating materials, a parting agent is fed into the coating channel, preferably at a slight distance from the distribution channel. Preferably, monomer materials are used as coating materials, which are mixed with one another directly before being fed into the distribution channel, or in the distribution channel. In this way, it is ensured that premature hardening is prevented and thus plugging up of the ring groove or of the coating channel takes place.

In an embodiment of the invention, it is provided that the coating materials are fixed in place on the tubular wall, during the coating process, over an extended period of time that is determined by the length of the coating channel and the transport speed of the tubular wall. In this way, it is ensured that a subsequent increase in volume is precluded, whereby the processing of non-foaming and foaming materials is possible. Because of the fact that the polyurethane mixture, for example, develops gas during the reaction, a foam is formed, which is compressed by means of the pre-determined gap volume, particularly by means of a conical run-out, and hardens. At the same time, the viscosity of the coating material increases as it cures, so that uniform and complete surface coating takes place.

The particular feature of the production method indicated consists in the fact that the coating materials are fixed in place on the tubular wall over an extended period of time, and this takes place, for example, as a result of the cylindrical or, in particular, conical narrowing of the coating channel. If a cylindrical coating channel is used, fixation on the tubular walls also takes place, so that the reactive coating materials harden in the available space. When using foaming materials, the gap between the coating device and the tubular wall is completely filled, as a result of the gas formation and expansion. In this connection, the time period for coating is pre-determined by the transport speed of the tubular wall and the length of the coating device with coating channel, so that it is assured that when the tubular wall exits from the coating device, curing of the coating materials has proceeded to such an extent that no further volume increase will take place. Flexible and foaming materials having different raw densities or non-foaming materials in filled or unfilled form can be used as a coating material. Possible fillers are, for example, talcum or a glass fiber, whereby the glass fiber additionally leads to reinforcement and stiffening of the coating materials.

In this connection, the coating materials (reactants) are mixed in a metering machine at pressures of 50 to 200 bar, using the counter-current principle, outside of the coating device, and introduced into the distribution channel at high pressure, so that at the same time, it is guaranteed that if at all possible, no coating materials remain adhering on the surfaces, which can lead to plugging up, in order to increase the useful lifetime of the coating device.

In a further development of the invention, it is provided that the reaction speed and thus the curing of the coating materials is additionally influenced by means of cooling or heating. During the entire process, the take-off speed of the tubular walls is coordinated with the discharge output of the metering machine, and is kept approximately constant during the coating process, so that as the result of the tubular wall to be coated being pushed through, a slight draft is built up, which draws the coating material, which thickens in the narrowing gauge of the coating head, with it, and as a result draws additional coating material out of the reaction chamber or ring groove. In this regard, coordination of the flow-through velocity and of the profile of the distribution channel and of the narrowing gauge must be carried out in an individual case for the different polyurethane mixtures. In this connection, foaming cellular or non-foaming, non-cellular coating materials, preferably poly-addition materials, are possible for use as coating materials. The coating is applied at a temperature of 35 to maximally 60 degrees, whereby attention is paid, in particular, to the fact that the polyurethane foam is not allowed to become too hot, so that for the special case of subsequent coating with aluminum foil that is laid around the pipe, thus forming a longitudinal seam, the aluminum does not expand too greatly.

A coating is applied in a layer thickness of 0.4 to 2 mm, preferably 0.6-1.2 mm, and is applied in the desired layer thickness, with slight tolerances, by means of the coating device according to the invention.

In addition, a tempering fluid can be used during the coating process, which makes it possible to allow the polyurethane mixture to cure while cooling, or also to accelerate the curing process with heat when the reaction is conducted accordingly. The decisive factor for the success of the method to be carried out is furthermore the configuration of the coating channel, which must be dimensioned to be sufficiently large and long. In order to improve the centered guidance of the tubular wall, the tubular wall that is possibly supplied coiled up is stretched and straightened. In order to improve the surface adhesion of the coating materials, the surface of the tubular wall, for example in the case of polyolefins, can be activated by means of heat or spark discharge.

According to the invention, a coating device is provided to carry out the method, into which a tubular wall can be fed in by way of an entry opening, and exits from an exit opening after coating has taken place, and the coating materials flow into a distribution channel, and from this into a coating channel, whereby the coating channel is pre-determined by means of a slit-shaped space between the surface of the tubular wall and the coating device. Other advantageous embodiments of the coating device are evident from the dependent claims.

The maximally available radius of the coating material is pre-determined by the pre-determined cross-section of the slit-shaped space that forms the coating channel, and as a result of the at least partial curing of the coating material, a very precisely maintained layer thickness is achieved. In this connection, the coating device consists, first of all, of an entry opening in which the tubular wall is held in centered manner, by means of shape fit, and transported in the direction toward the coating channel until it exits from the exit opening. The distribution channel consists of an inner ring groove, whereby the inside diameter, starting from the ring groove, widens by the cross-section of the coating channel, in the transport direction of the tubular wall. In this connection, attention must be paid to the fact that the cross-section of the coating channel is adapted to the desired thickness of the layer to be applied, on the output side. The layer thickness to be applied can be pre-determined, for this purpose, by means of a uniform cross-section or by means of a cross-section that narrows conically in the direction toward the exit opening. This can preferably be done by means of an interchangeable gauge that is held in the exit opening, so that it can be pressed, pushed, or screwed in, in order to determine the clear width of the cross-section of the coating channel. As a result, there is the advantage that tubular walls having different diameters and different layer thicknesses can be coated by means of simple replacement of the gauge, in each instance. Metal pipes, particularly steel pipes, or flexible plastic pipes, for example polyolefin or PE pipes, are possible as tubular walls. In this connection, metal pipes are processed in available lengths, while flexible plastic pipes are generally processed in coiled-up form. For this purpose, the flexible pipes are delivered rolled up on storage rolls, so that first, straightening and stretching of the tubular walls is required. Furthermore, the surface can be activated by means of heat or spark discharge, before the tubular walls are passed through the coating device. Particularly good adhesion of the coating materials to the surface of the tubular walls, particularly of the polyolefin pipes, is achieved by means of prior activation of the surface.

The front end of the tubular wall is first of all centered in the coating device by means of shape fit. For this purpose, a centering device is provided, for example, which preferably consists of at least three slide guides that are disposed offset by 120°, in each instance. The individual slide guide consists of an adjustment screw with ball or roller and pressure spring, whereby the ball or roller lies against the tubular wall and holds it centered in the coating device.

In an embodiment of the invention, it is provided that the gauges consist of a non-adhering plastic, for example Teflon, or of a material, for example pure nickel, whose adhesion strength is less than the cohesion strength of the coating materials used, so that no adhesions form, if at all possible, and thus plugging up of the coating channel is prevented or at least delayed. To further reduce an adhesion on the gauge used, the feed of a parting agent or a foil is provided. For this purpose, there is another feed for a parting agent or a foil in the transport direction of the tubular wall, behind the distribution channel, whereby the feed consists of a second feed channel, a tap channel, and a bowl-shaped depression that lies on the inside, in the gauge. By means of this measure, the result is achieved that a uniform parting agent film is drawn onto the coating materials used, while they are still within the gauge.

In a further embodiment of the invention, it is provided that a cooling and/or heating device is provided coaxial to the coating channel, in order to subsequently influence the reaction speed of the coating materials. Likewise, in a further embodiment of the invention, there is the possibility of providing a channel for a tempering fluid at the exit opening, with which the reaction of the coating material can also be influenced.

In an embodiment of the invention, it is furthermore provided that the coating device has multiple, preferably three, feed channels for the distribution channel, distributed over the circumference, so that the coating materials, for example polyurethane components, get into the distribution channel quickly and free of dead volume.

The significant advantage of the coating device and of the method used consists in very precise adherence to the pre-determined layer thickness. This is necessary, for example, in order to apply an aluminum film provided with a longitudinal seam so that it overlaps. In the case of greater variations in layer thickness, this could lead to the situation, for example, that the aluminum strips does not completely surround the tubular wall. In addition, the aluminum foil is structured after it is glued onto the permanently elastic polyurethane layer around the polyethylene pipe. For this purpose, a helical depression can be made around the pipe, for example, whereby the distance between the grooves, in the expansion direction of the pipe, amounts to approximately 5 mm. The grooves are introduced in the heated state of the aluminum foil and the coating, therefore attention must be paid to ensure that the temperature does not exceed certain values, because otherwise, the depressions that are made in the layer structure are drawn smooth again during subsequent cooling, as the result of temperature-related shrinkage. Additional layers of the finished conduction pipe follow, such as a polyurethane foam layer having a thickness of several centimeters, and on top of that, in turn, a layer of black, corrugated polyethylene, for example. The individual coating materials can additionally be provided with a reinforcement of reinforcement material, for example woven fiberglass or hard celluloses or non-cellulose material.

A composite pipe produced according to the method, using the coating device, consists of a pipe core of metal or plastic, for example polyolefin, preferably polyethylene, whereby for gluing on other layers, particularly the outer layer, polyurethane is applied, which is configured to be permanently elastic and compressible, and, in a special embodiment, can have a thin aluminum foil wrapped around it. The composite pipe configured in this manner can subsequently be structured, after the aluminum foil is glued onto the polyurethane layer, preferably with a helical depression, whereby the distance between the grooves, in the expansion direction of the tubular wall, amounts to approximately 2 mm to 5 cm, preferably 5 mm to 1 cm. By means of this measure, tearing of the aluminum layer as the result of inherent movement of the composite pipe is precluded, to the greatest possible extent. Subsequently, a polymer foam layer having a thickness of several centimeters is applied to the aluminum foil; it is essentially intended for insulation. Finally, application of a corrugated polyethylene layer onto the polymer foam layer takes place, in order to prevent damage to the tubular wall.

By means of the method according to the invention as shown, and the coating device, a possibility is therefore indicated for providing a tubular wall with a thin and precisely maintained coating, so that in a subsequent work process in a special embodiment, for example, an aluminum foil that is present in strip form is laid around the pipe and glued on with the coating materials. The requirements of maintaining a very precise layer thickness are met by the coating device, with extremely close tolerances, in advantageous manner. In this way, machine production can be built up, without interruptions, at high capacity, and thus cost-advantageous production of the composite pipes can be carried out.

In the following, the invention will be explained once again, using the figures listed below.

These show:

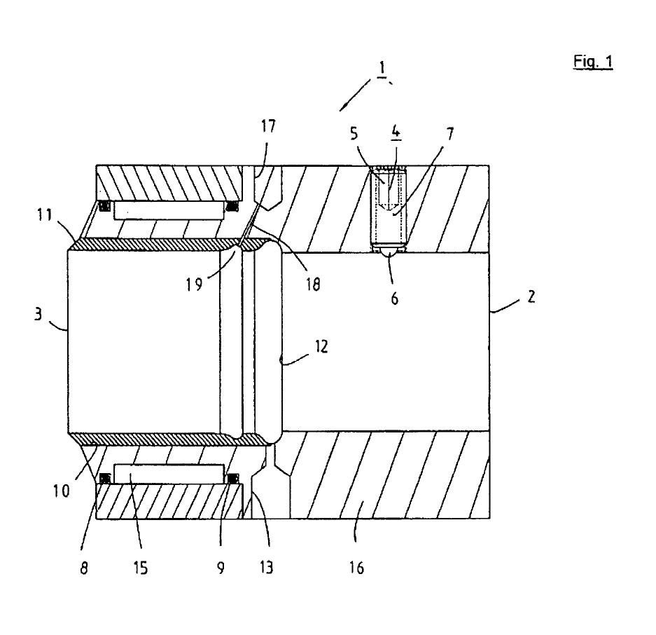

FIG. 1 the coating device according to the invention, in a sectional side view,

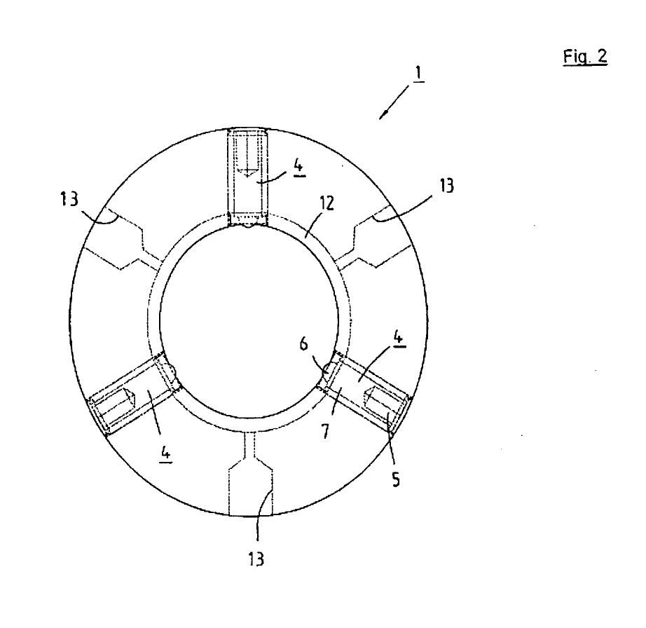

FIG. 2 the coating device according to FIG. 1, in a sectional top view,

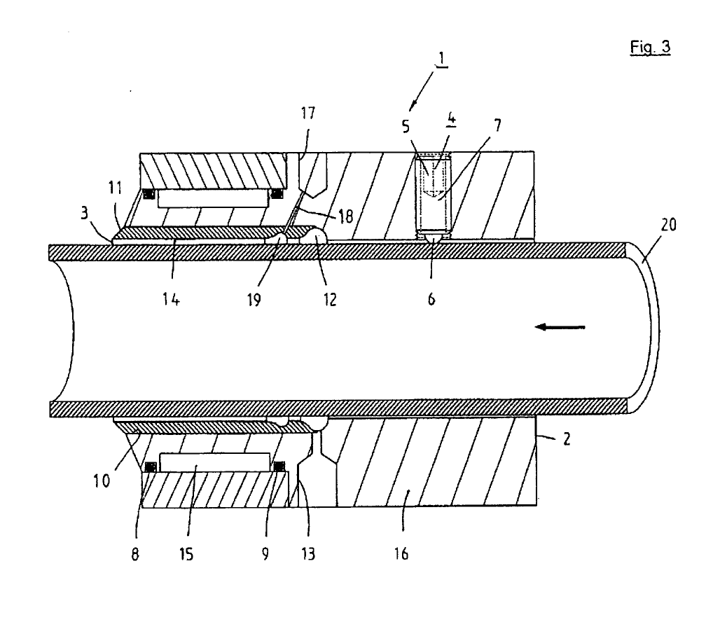

FIG. 3 the coating device according to the invention, according to FIG. 1, with a tubular wall, in a sectional side view,

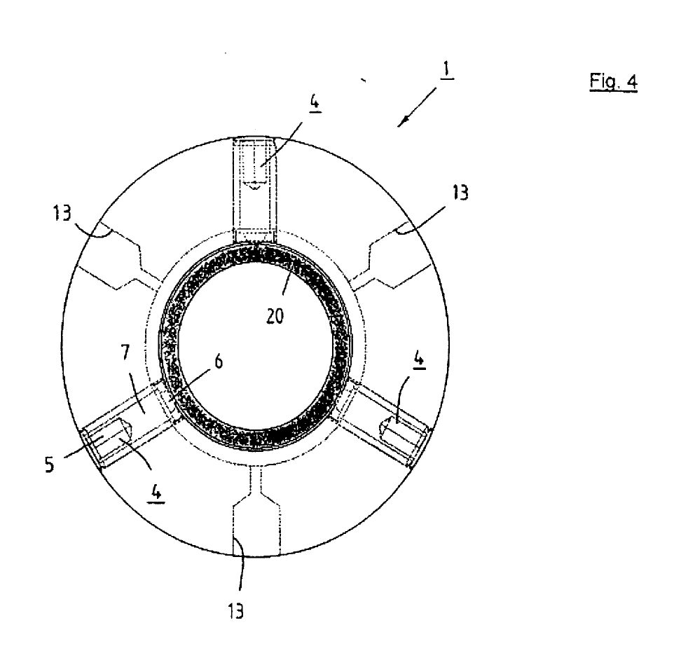

FIG. 4 a sectional top view according to FIG. 3,

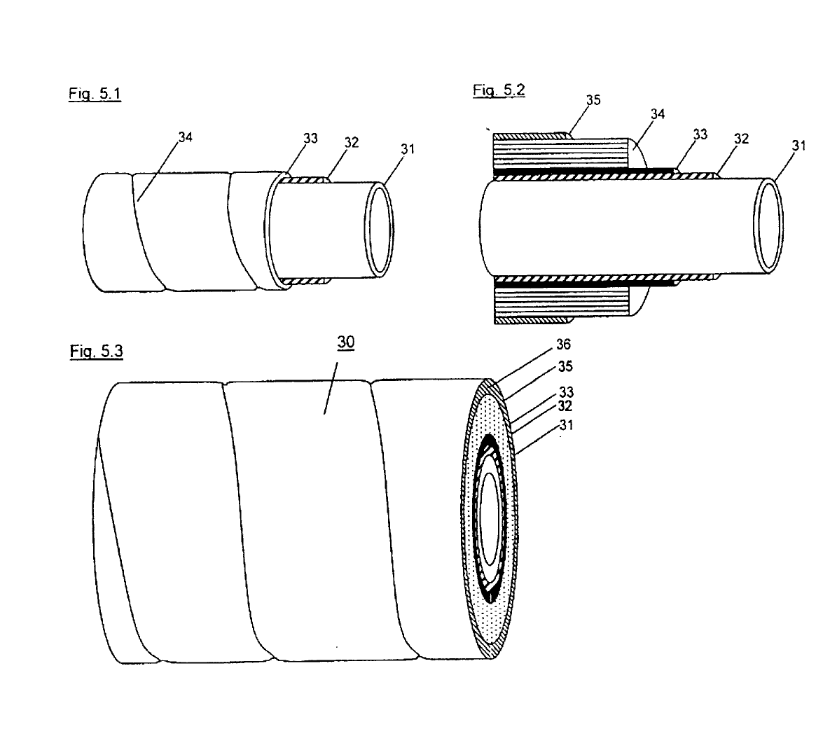

FIG. 5 a composite pipe according to the invention, in a sectional side view, in three detailed individual views, and

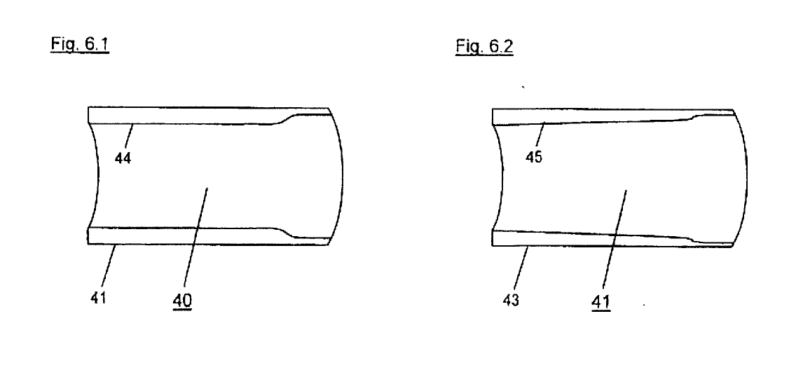

FIG. 6 two different gauges for use with the coating device according to the invention.

FIG. 1 shows a coating device 1 according to the invention, which has an entry opening 2 and an exit opening 3. Multiple centering devices 4 are provided for centered accommodation of a tubular wall, not shown, which are disposed distributed over the circumference, preferably offset by 120°, in each instance. Preferably, at least three centering devices 4 are used. The centering device 4 consists of an adjustment screw 5 and a ball 6 with pressure spring 7. Alternatively, a roller can be used in place of the ball 6. Thus, the roller or ball 6 lies against the tubular wall and centers it in the coating device 1. In this connection, the entry opening 2 is selected, in terms of size, in such a manner that different tubular walls can be fed in and held, because of the adjustable centering device 4. A larger lathed-in region 10 is present on the opposite side of the entry opening 2, in which a gauge 11 is accommodated. The gauge 11 is configured to be interchangeable and can be held by means of a press fit or a thread, for example, and determines the outside diameter of the coating by means of its inside diameter.

In the center, there is a distribution channel 12 that lies on the inside of the coating device 1, which is fed by means of multiple, preferably three feed channels 13 that are distributed over the circumference. The reactive coating component is fed in by way of the feed channels 13. In this connection, the coating materials (reactants) are mixed in a metering machine at pressures of 50 to 200 bar, using the counter-current principle, outside of the coating device 1, and introduced into the distribution channel 12 at high pressure, so that it is guaranteed, at the same time, if at all possible, that no coating materials remain adhering to the surfaces and might bring about plugging up, in order to increase the useful lifetime of the coating device 1. It is ensured, according to the invention, by means of the geometry of the distribution channel and the intended pressure, that a space free of dead volume is formed, in which no residues of coating materials can adhere to the walls, in particular. This is guaranteed, for example, by means of the high pressure feed. The coating channel 14 is formed, with regard to cross-section, by means of the tubular wall that lies within the device and the inside diameter of the gauge 11. In this connection, the inside diameter has been selected in such a manner that the cross-section has been selected, at least on the output side, in accordance with the layer thickness to be applied, whereby the inside diameter of the gauge 11 is always configured to be greater than the inside diameter of the entry opening 2. In a first embodiment variant, the gauge 11 can have a uniform diameter, so that a cylindrical cross-section is present over the entire path distance. Alternatively, there is the possibility that the inside diameter of the gauge 11 narrows toward the exit side, and thus additional compression of the coating materials to be applied occurs, for example in the case of foam products. In this connection, the gauge 11 is preferably configured to be interchangeable, so that different layer thicknesses can be applied with one coating device 1. In order to avoid adhesion of coating materials on the inside of the gauge 11, a second feed channel 17 for a parting agent is furthermore provided. The feed channel 17 makes a transition into a tap channel 18 that ends in a bowl-shaped depression 19. The depression 19 is provided on the inside of the gauge 11 and is situated in the immediate vicinity of the distribution channel 12, thus the parting agent is applied directly to the outer surface of the coating material and prevents adhesion to the inside of the gauge.

To influence the reaction period and curing of the coating materials, a tempering device 15 that lies on the outside is furthermore provided in a lathed-out region, which allows cooling or heating of the coating device 1, for example, and thus influences curing of the coating materials. The tempering device is sealed, with regard to the housing 16 of the coating device 1, by means of seals 8, 9. The length of the gauge 11 was selected in such a manner that solidification of the coating materials has already started at the time of exit from the coating device 1, taking the transport speed of the tubular wall into consideration, and thus the intended outside diameter of the tubular wall, with a pre-selected layer thickness, is maintained very precisely. Subsequent to application of the coating materials, in a special case, wrapping an aluminum foil around the tubular wall, in the form of a longitudinal strip that is adapted to the diameter of the tubular wall with coating material, can take place. Alternatively, spiral wrapping can take place.

The coating device 1 can also be seen in FIG. 2, in a sectional top view, specifically with three centering devices 4 that are each offset by 120°, as well as three feed channels 13 that are disposed offset by 120°, in each instance, whereby these in turn are disposed offset by 60° with regard to the centering devices 4, in each instance. The centering devices 4 consists of the setting screw 5, a pressure spring 7, and a ball 6 that rests against the tubular wall, as already shown in FIG. 1, while the feed channel 13 narrows in the direction toward the distribution channel 12 and is intended for pressing the coating materials in. The clear width of the coating device 1 is determined by the gauge 11 that is pushed in on the exit side, which is interchanged in accordance with the layer thickness to be selected. The number of feed channels 13 and that of the centering devices 4 can be increased if necessary. FIG. 2 shows a first exemplary embodiment merely as an example.

The coating device 1 already known from FIG. 2 is shown in FIG. 3, with a tubular wall 20, for example a PE pipe, lying in it. In this sectional side view, the coating channel 14 and the centered mounting of the tubular wall 20 can be seen very clearly. The tubular walls 20, if they consist of plastic, are generally supplied in coiled-up form, so that first of all, straightening and stretching of the tubular wall 20 is required before it/they are introduced into the coating device 1. Accommodation and centering of the tubular wall 20 takes place, in the coating device 1, by means of the centering device 4, so that a uniform gap formation around the tubular wall 20 is present, with a pre-determined layer thickness in accordance with the selected gauge 11. The reactive coating materials are fed into the distribution channel 12 by way of the feed channel 13, at a pressure of up to 200 bar, and get from there into the coating channel 14. The length of the coating channel 14 is pre-determined by means of the gauge 11, and determined in such a manner that, taking the transport speed into consideration, curing of the coating materials already starts in the coating channel 14, and the coating materials have hardened to such an extent, when the tubular wall 20 exits from the exit opening 3, that the pre-determined layer thickness is maintained very precisely. In addition, there is the possibility of influencing the reaction capability of the coating materials by means of cooling or heating, and of preventing adhesion to the inside wall of the gauge 11 by means of adding a parting agent by way of the feed channel 17.

FIG. 4 shows the coating device 1 according to FIG. 3 in a sectional top view, with a tubular wall 20 lying inside it.

FIG. 5 shows a composite pipe 30 according to the invention, which is produced from a tubular wall 31. The composite pipe 30 according to the invention is shown in FIGS. 5.1, 5.2, and 5.3, in several individual production steps. A polyurethane layer 32 is applied around the tubular wall 31 in a first work step, using the coating device described, and then sheathing with an aluminum foil 33 takes place. Preferably, the aluminum foil 33 is applied in the form of a very thin layer, which is shown slightly thicker in the drawing, in order to be able to show it better. The aluminum layer 33 has helical depressions 34 on its surface, so that tearing of the aluminum foil 33 is prevented for further processing. A polymer foam layer 35 that can have a thickness of several centimeters is applied around the aluminum foil 33. Finally, a corrugated layer 36, preferably of polyethylene, is wrapped on, which is supposed to prevent damage to the composite pipe 30, as a protective layer.

FIG. 6 shows different embodiments of a gauge 40, 41, in two figure parts 6.1 and 6.2, as it can be pressed or screwed into the coating device 1. The two gauges 40, 41 have an axially symmetrical outer surface 42, 43, while the inner surface 44 is configured to be straight in the case of the gauge 40, and the inner surface 45 has a conical shape in the case of the gauge 41. Depending on the intended purpose of use, the gauges 40, 41 can be used interchangeably in the coating device, in order to achieve a desired compression of the polyurethane layer.

### REFERENCE SYMBOL LIST

1 coating device
2 entry opening
3 exit opening
4 centering device
5 adjustment screw
6 ball
7 pressure spring
10 lathed-in region
11 gauge
12 distribution channel
13 feed channel
14 coating channel
15 tempering device
16 housing
17 feed channel
18 tap channel
19 depression
20 tubular wall
30 composite pipe
31 wall
32 polyurethane layer
33 aluminum foil
34 depression
35 polymer foam layer
36 layer
40 gauge
41 gauge
42 outer surface
43 outer surface
44 inner surface
45 inner surface

1. Method for uniform application of a coating of coating materials capable of reaction, preferably polyurethane components, onto tubular walls (20),
characterized by
the continuous feed of the tubular wall (20) into a coating device (1), in which coating materials are passed to at least one distribution channel (12) free of dead volume, which opens toward the tubular wall (20) and makes a transition, in the transport direction, into a coating channel (14), whereby the coating materials flow into the distribution channel (12) and get from there to the surface of the tubular wall (20), and are held in a closely limited space until they solidify.

2. Method according to claim 1,
characterized in that
the coating is applied to the outside of the tubular wall (20).

3. Method according to claim 1,
characterized in that
after feed of the coating materials, a parting agent is fed into the coating channel (14), preferably at a slight distance from the distribution channel (12).

4. Method according to claim 1, 2, or 3,
characterized in that
the coating materials, preferably monomer materials, are mixed directly before being fed into the distribution channel (12), or in the distribution channel (12).

5. Method according to claim 1,
characterized in that
the coating materials are fixed in place on the tubular wall (20), during the coating process, over an extended period of time that is determined by the length of the coating channel (14) and the transport speed of the tubular wall (20).

6. Method according to claim 1,
characterized in that
at least partial curing of the coating materials, particularly of a cellular polyurethane mixture, takes place in a conical narrowing of the coating channel (14).

7. Method according to claim 1,
characterized in that
the gas volume and material volume is compressed by means of a conical run-out of the coating channel (14).

8. Method according to claim 1,
characterized in that
the coating materials are mixed in a metering machine at pressures of 50 to 200 bar, using the counter-current principle, outside of the coating device (1), and introduced into the distribution channel (12) at high pressure.

9. Method according to claim 1,
characterized in that
the reaction speed of the coating materials is influenced by means of cooling or heating.

10. Method according to claim 1,
characterized in that
the take-off speed of the tubular walls (20) in the coating channel (14) is coordinated with the discharge output of the metering machine, and kept approximately constant during the coating process.

11. Method according to claim 1,
characterized in that
foaming cellular or non-foaming, non-cellular coating materials, preferably poly-addition materials, are used for the coating.

12. Method according to claim 1,
characterized in that
the coating is applied at a temperature of 35 to 60 degrees.

13. Method according to claim 1,
characterized in that
the coating is applied in a layer thickness of 0.4 to 2.0 mm, preferably 0.6-1.2 mm.

14. Method according to claim 1,
characterized in that
the tubular wall (20) consists of metal pipes or plastic pipes, preferably polyolefin pipes.

15. Method according to claim 1,
characterized in that
the tubular wall (20) to be coated is stretched and straightened before coating occurs, if flexible plastic pipes are used.

16. Method according to claim 1,
characterized in that
the tubular wall (20) to be coated is activated by means of heat or by means of spark discharge on the surface, if polyolefin pipes are used.

17. Coating device (1) for uniform application of a coating of coating materials capable of reaction, preferably polyurethane components, onto tubular walls (20), whereby the tubular wall (20) can be fed in by way of an entry opening (2) and exits from an exit opening (3) after coating has taken place,
characterized in that
the coating materials flow into a distribution channel (12), and from this into a coating channel (14), whereby the coating channel (14) is formed by means of a slit-shaped space between the surface of the tubular wall (20) and the coating device (1).

18. Coating device according to claim 17,
characterized in that
the distribution channel (12) consists of an inner ring groove, whereby the inside diameter, starting from the ring groove, widens by the inside diameter of the coating channel (14), in the transport direction of the tubular wall.

19. Coating device according to claim 18,
characterized in that
the diameter of the coating channel (14) is adapted, on the output side, to the thickness of the coating (32) to be applied.

20. Coating device according to claim 17, 18, or 19,
characterized in that
the coating channel (14) has a uniform diameter, or that the coating channel (14) is structured to narrow conically in the direction of the exit opening (3).

21. Coating device according to claim 20,
characterized in that
an interchangeable gauge (11, 40, 41) is held in the exit opening (3), so that it can be pressed, pushed, or screwed in, which gauge determines the clear width of the diameter of the coating channel (14).

22. Coating device according to claim 21,
characterized in that
the gauges (11, 40, 41) consist of a non-adhering plastic, or of a material, whose adhesion strength is less than the cohesion strength of the coating materials used.

23. Coating device according to claim 22,
characterized in that
the tubular wall (20) is configured so that it can be guided in the coating device (1) with a shape fit and centered.

24. Coating device according to claim 23,
characterized in that
in the transport direction of the tubular wall (20), behind the distribution channel (12), another feed for a parting agent or a foil is provided, whereby the feed consists of a second feed channel (17), a tap channel (18), and a bowl-shaped depression (19) that lies on the inside, in the gauge (11).

25. Coating device according to claim 24,
characterized in that
a centering device (4) for the tubular wall (20) consists of at least three slide guides that are disposed offset by 120°, in each instance.

26. Coating device according to claim 25,
characterized in that
the slide guide consists of an adjustment screw (5) with ball (6) or roller and pressure spring (7).

27. Coating device according to claim 26,
characterized in that
a tempering device (15) a cooling and/or heating device, is provided coaxial to the coating channel (14).

28. Coating device according to claim 27,
characterized in that
it has multiple, feed channels (13) for the distribution channel (12), distributed over the circumference, through which the polyurethane components can be fed in.

29. Coating device according to claim 28,
characterized in that
a recess for a tempering device (15) is configured on the side of the exit opening (3).

30. Composite pipe, produced by means of continuous feed of a tubular wall (20, 31) into a coating device (1), in which coating materials can be fed to at least one distribution channel (12) free of dead volume, which opens toward the tubular wall (20, 31) and makes a transition into a coating channel (14) in the transport direction, whereby the coating materials flow into the distribution channel (12), and get from there to the surface of the tubular wall (20, 31), and are enclosed in a closely limited space until they solidify, whereby the composite pipe (30) consists of a pipe core of metal or plastic, for example polyolefin, and for gluing on other layers, a polyurethane layer (32) is applied, which is configured to be permanently elastic and compressible, and has a closely tolerated coating, and has a thin aluminum foil (33) wrapped around it.

31. Composite pipe according to claim 30,
characterized in that
the aluminum foil (33) is structured after it is glued onto the polyurethane layer (32), with a helical depression (34), whereby the distance between the grooves, in the expansion direction of the tubular wall, amounts to approximately 2 mm to 5 cm, preferably 5 mm to 1 cm.

32. Composite pipe according to claim [[30 or]] 31,
characterized in that
a polymer foam layer (35) having a thickness of several centimeters is applied to the aluminum foil (33).

33. Composite pipe according to claim 30, 31, or 32,
characterized in that
a corrugated layer (36) of polyethylene is applied to the polymer foam layer (35).
